(19) United States
(12) Patent Application Publication
(10) Pub. No.: US 2012/0267832 A1
(43) Pub. Date: Oct. 25, 2012

(54) METHOD AND DEVICE FOR BLOW-MOLDING CONTAINERS

(75) Inventors: Tara Zocher, Hamburg (DE); Karl-Heinz Balkau, Oststeinbek (DE); Jens-Peter Rasch, Ahrensburg (DE); Deniz Ulutürk, Hamburg (DE); Martin Matthiesen, Hamburg (DE); Frank Lewin, Tangstedt (DE); Michael Linke, Hamburg (DE)

(73) Assignee: KHS CORPOPLAST GMBH, Hamburg (DE)

(21) Appl. No.: 13/384,512

(22) PCT Filed: Jul. 14, 2010
(86) PCT No.: PCT/DE2010/000837

§ 371 Date: Jul. 3, 2012

(30) Foreign Application Priority Data
Jul. 16, 2009 (DE) 10 2009 033 902.7

(51) Int. Cl. B29C 49/64

(52) U.S. Cl. 264/458; 264/454; 425/174.4

(57) ABSTRACT

The invention relates to a method and a device for blow-molding containers. A preform produced of a thermoplastic material is subjected to a thermal conditioning process along a transport path in the region of a heating section. The preform is then shaped in a blow mold by the effect of a blowing pressure to give the container. The preform is subjected to a temperature profile at least along part of its transport path in the region of the heating section, said temperature profile being generated by at least one tubular radiation heater. The temperature profile extends in a longitudinal direction of the preform. The radiation emitted by the radiation heater is emitted in different spatial directions with different intensities by a heating device positioning the radiation heater.

The invention relates to a method for blow molding containers, in which a preform of a thermoplastic material is, after a thermal conditioning along a transport path in the area of a heating section, deformed within a blow mold into the container by the application of blowing pressure, and in which the preform is provided, at least along a portion of its transport path in the area of the heating section, with a temperature profile which extends in a longitudinal direction of the preform. The temperature profile is provided by at least one heating device which is provided with at least one tubular heating radiator.

Moreover, the invention relates to a device for blow molding containers of a thermoplastic material, the at least one heating section arranged along a transport path of the preform, and a blow molding station provided with a blow mold and in which, along at least a portion of the transport path of the preform, a device for producing a temperature profile is arranged in the area of the preform, wherein the temperature profile extends in a longitudinal direction of the preform, and wherein, for generating a heat radiation, at least one tubular heating radiator is used in the area of the heating device.

When forming containers by the influence of blowing pressure, preforms of a thermoplastic material, for example, preforms of PET (polyethylene terephthalate) are fed within a blow molding machine to various processing stations. Typically, such a blow molding machine has a heating device as well as a blowing device in whose areas the previously thermally conditioned preform is expanded by biaxial orientation into a container. The expansion takes place by means of compressed air which is introduced into the preform to be expanded. The technical sequence in such an expansion of the preform is explained in DE-OS 43 40 291. The introduction of the pressurized gas mentioned in the beginning, also includes the introduction of pressurized gas into the developing container bubble as well as the compressed gas introduction into the preform at the beginning of the blow molding process.

The basic construction of a blow molding station for forming containers is described in DE-OS 42 12 583. Possibilities for thermally conditioning the preforms are explained in DE-OS 23 52 926.

Within the device for blow molding, the blow molded containers can be transported by means of various manipulating devices. Particularly the use of transport mandrels, onto which the preforms are placed, has been found to be advantageous. However, the preforms can also be manipulated by other support devices. The use of gripping tongs for manipulating preforms and the use of spreading mandrels, which for support can be inserted into an area of the opening of the preform, are also among the available constructions.

A manipulation of containers with the use of transfer wheels is described, for example, in DE-OS 199 06 438, in an arrangement of the transfer wheel between a blow wheel and a discharge section.

The manipulation of the preforms already explained above takes place, on the one hand, in the so-called two-stage methods, in which the preforms are initially manufactured by an injection molding process, are subsequently subjected to intermediate storage, and are only later thermally conditioned and blown up into a container. On the other hand, the manipulation takes place in the so-called single-stage methods in which the preforms are thermally conditioned directly after their manufacture by injection molding technology and, after a sufficient solidification, the preforms are thermally conditioned and blown into a container.

With respect to the blow molding stations used, different embodiments are known. In blow molding stations, which are arranged on rotating transport wheels, a book-like opening of the mold carriers can be found frequently. However, it is also possible to utilize mold carriers which are moveable relative to each other or are guided in another manner. In stationary blow molding stations, which are particularly suited for receiving several cavities for forming containers, plates extending parallel to each other are typically used as mold carriers.

Prior to carrying out heating, the preforms are typically placed on transport mandrels which either transport the preform through the entire blow molding machine, or which merely circulate in the area of the heating device. In the case of an upright heating of the preforms, such that the openings of the preforms are oriented downwardly in the vertical direction, the preforms are usually placed on a sleeve-shaped holding element of the transport mandrel. In the case of a hanging heating of the preform, in which the preforms are oriented with their openings upwardly in the vertical direction, as a rule spreading mandrels are inserted into the openings of the preforms, which tightly clamp the preforms.

A significant problem in the use of conventional infrared radiators for heating the preforms resides in that the predominant portion of the radiation is converted into heat already in the immediate vicinity of the surface of the preform, and that a thermal conditioning of the inner wall areas of the preform takes place only due to the spreading of heat within the thermoplastic material. Since the thermoplastic material has distinct thermally insulating properties, a sufficient spreading of heat requires a time for heating of the preform of about 20 seconds. For avoiding overheating of the surface areas of the preform, blowing against the preform with cooling air is carried out simultaneously with heating. This results in relatively high energy consumption for carrying out heating.

For reinforcing an active heating of the preform, which is as uniform as possible through the wall thickness of the preform, it is also known, alternatively or as a supplement to heating with infrared radiators, to carry out heating with HF-radiation or microwave radiation. However, these types of radiation make it necessary to use screens in order to prevent or reduce the escape of radiation. Moreover, a conversion of this radiation in the preform material into heat has been found to be time consuming, so that no significant reduction of the heating required heating times could be achieved.

For reducing the necessary heating time, it is also already known to use NIR-radiators in the area of the heating section whose heat radiation is emitted in a near infrared area, typically with wave lengths of between 0.4 and 1 micrometer. For optimizing the energy utilization, such heating sections are equipped with a plurality of mirror surfaces, in order to avoid as much as possible, or at least significantly reduce, absorption of the heat radiation by structural components of the heating section. However, in the operation of such heating sections, it has been found that the heat distribution within the preforms deviates from predetermined temperature profiles.

A particular problem occurs if the preforms are not to be provided, in the areas of the entire extensions, with a temperature which is as uniform as possible, but if the temperature profiles already mentioned above are to be generated. The problem in generating such temperature profiles is the fact that the radiator tubes radiate the heating radiation relatively uniformly at least in one circumferential direction of the tubes. By using reflectors, it is ensured that a heating energy which has been radiated in a direction facing away from the preforms is cast back and conducted in the direction toward the preforms.

For generating temperature profiles, it is known to use for example, shutters which shade certain areas of the preforms relative to the heat radiation. Also already known in the art are lens-like elements for focusing the radiation, or curved reflectors, which reinforce radiation directed in the direction of the preforms.

It is the object of the present invention to improve a method of the above-mentioned type in such a way that a predetermined temperature distribution is achieved within the preforms.

In accordance with the invention, this object is met in that the radiation emission of the heat radiator is radiated by the heating device positioning the heating radiator in different spatial directions with different intensities.

Another object of the present invention is to construct a device of the above-mentioned type in such a way that the preforms are provided with a predetermined temperature profile.

In accordance with the invention, this object is met in that the heating device positioning the heating radiator is constructed for radiating the radiation emission of the heating radiator with different intensities in different spatial directions.

By constructing the heating device in such a way that the radiation emission takes place in different spatial directions with different and predetermined intensities, it is especially possible to select those portions of the heating energy which impinge upon different vertical levels of the preforms, in such a way that the respectively desired temperature profile is achieved. In this connection, the areas to be heated to a higher temperature are radiated with a higher heating power, and the areas to be heated to a lower temperature are radiated with a lower heating power. In particular, it is also possible to predetermine the distribution of the radiation emission in such a way that certain areas of the preform are not at all subjected to impinging heating radiation.

A variation of the radiation alignment resides in that a focusing reflector is used for influencing the spreading of the heating radiation.

In particular, for bundling the radiation it has been found useful if the focusing reflector is at least over areas thereof with an elliptical shape.

A long usefulness of the heating device is reinforced by positioning the heating radiator in the area of the focusing reflector with end sections which are bent in the direction toward the reflector surface.

For reinforcing a low-loss heating of the preforms it is being considered to use heating radiators for generating a NIR-radiation.

An effective focusing of the radiation can be achieved if the heating radiator is positioned within a receiving space defined by the focusing reflector and at a short distance from the reflector surface.

Another alignment of the radiation is reinforced by using at least one screen for shading.

In particular, it is intended that the screening is used for shading at least one circumferential area of the radiator tube.

A compact construction can be achieved by positioning the screening as a coating on the heating radiator.

A use even at high operating temperatures of the heating radiator is reinforced by using a ceramic material as screening.

For producing blow molded containers it has been found especially useful to position the heating device at an end of a heating section.

In the drawings, embodiments of the invention are schematically illustrated. In the drawing:

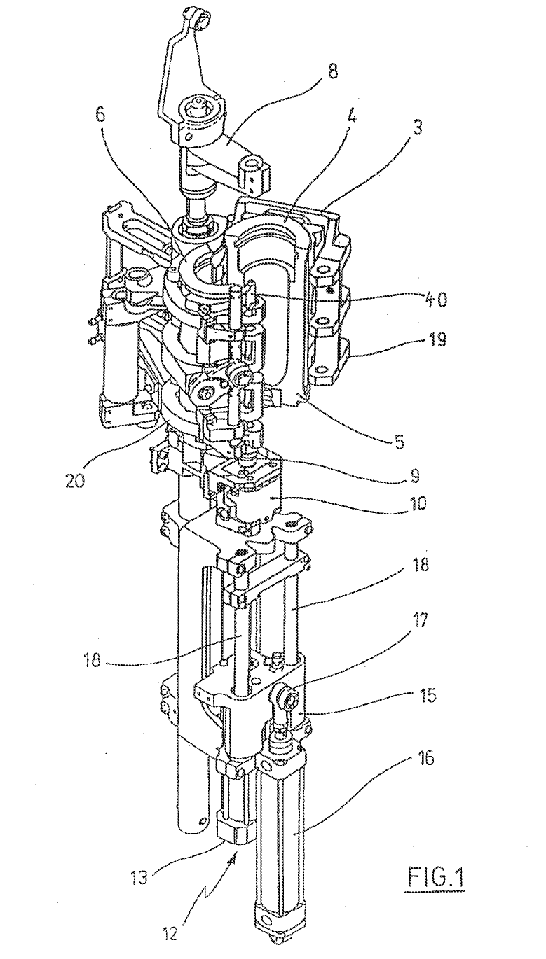

FIG. 1 is a perspective illustration of a blow molding station for manufacturing containers from preforms,

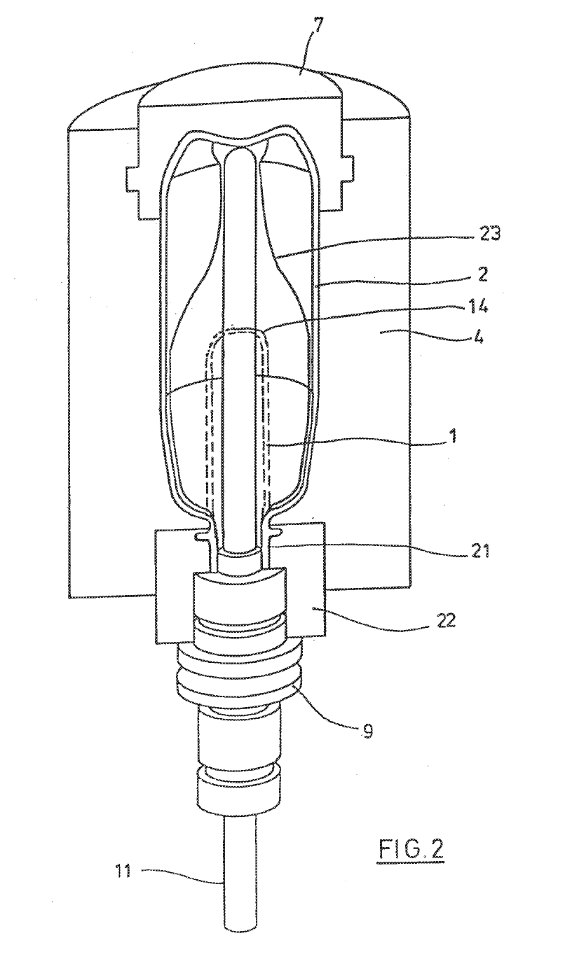

FIG. 2 is a longitudinal sectional view of a blow mold in which a preform is stretched and expanded,

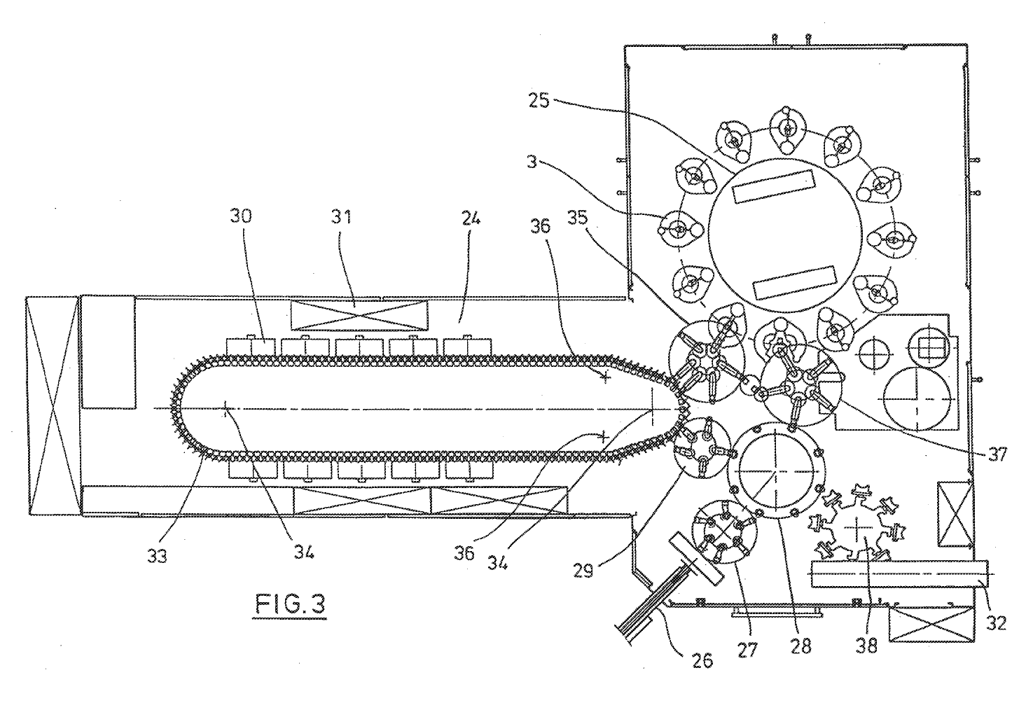

FIG. 3 is a sketch for illustrating a basic construction of a device for blow molding containers,

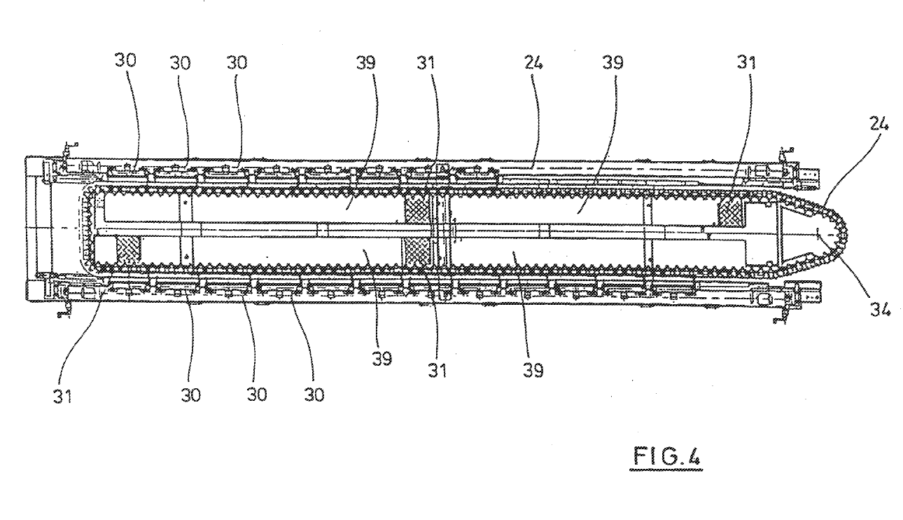

FIG. 4 shows a modified heating section with increased heating capacity,

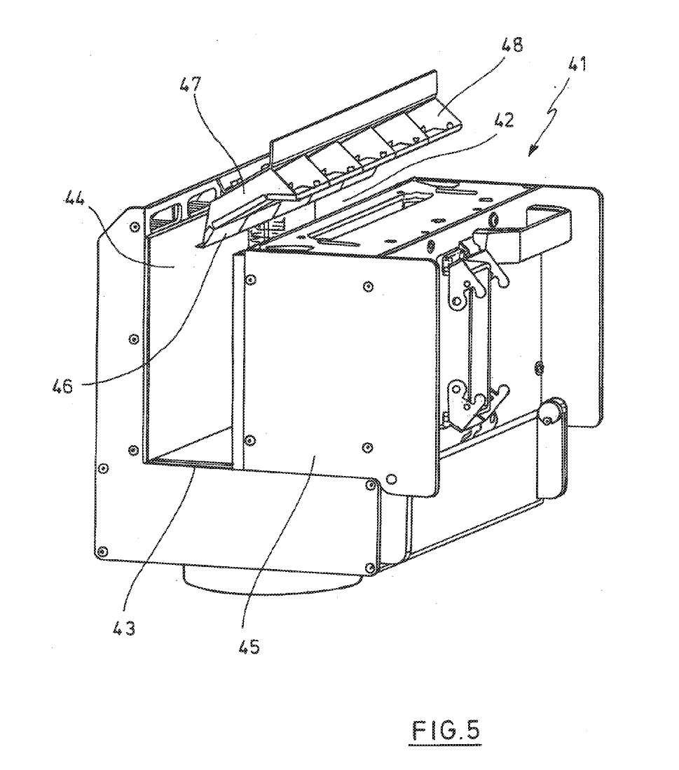

FIG. 5 is a perspective illustration of a heating module in the area of the heating section,

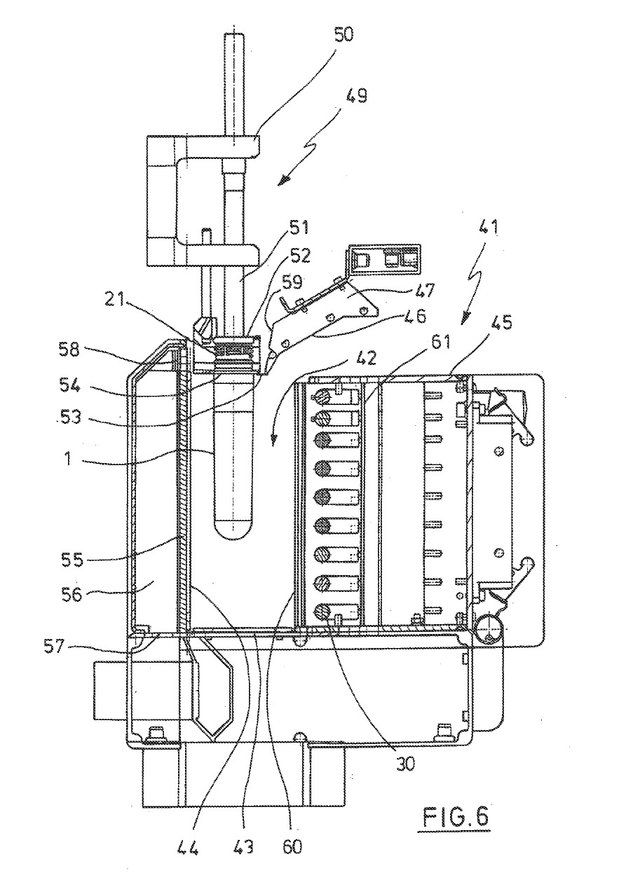

FIG. 6 is a cross sectional view of the heating module according to FIG. 5,

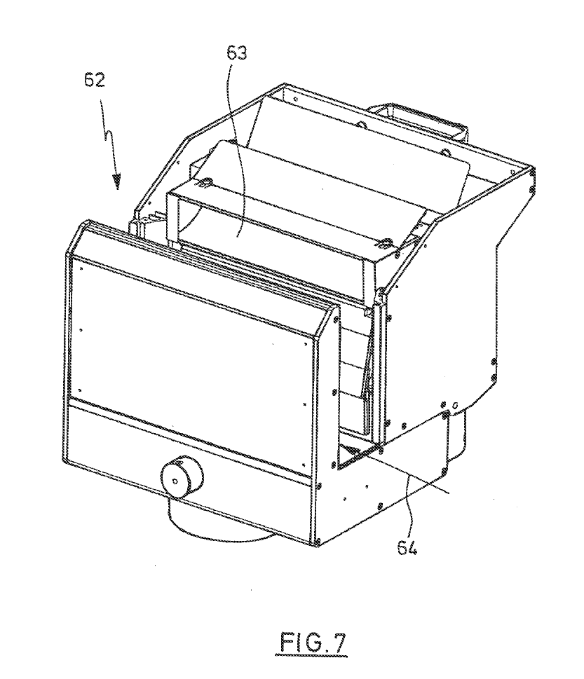

FIG. 7 is a perspective illustration of a heating box for reinforcing a temperature profile of the preforms,

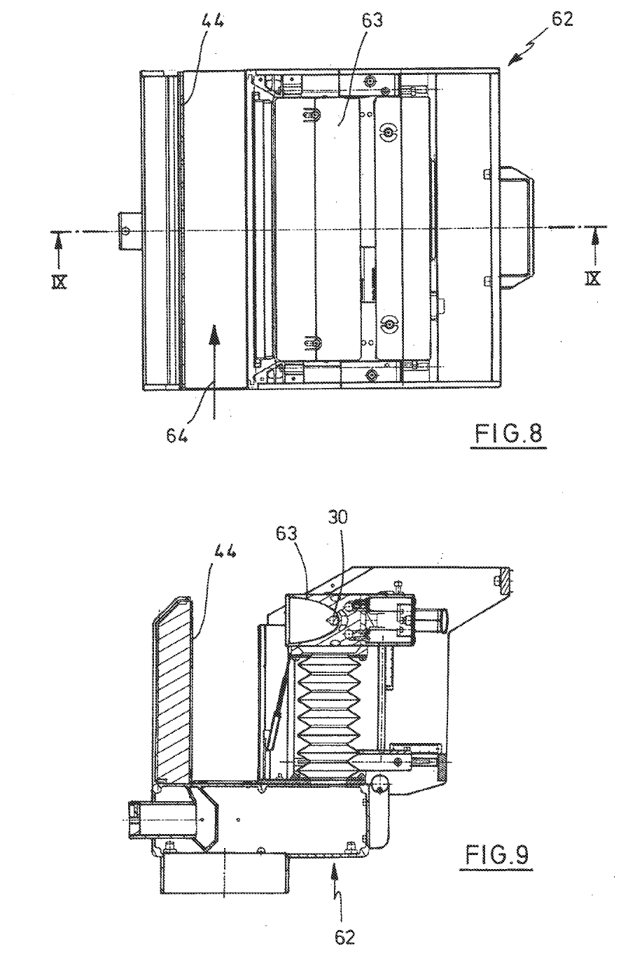

FIG. 8 is a top view of the heating box according to FIG. 7,

FIG. 9 is a cross sectional view along sectional line TX-Ix in FIG. 8,

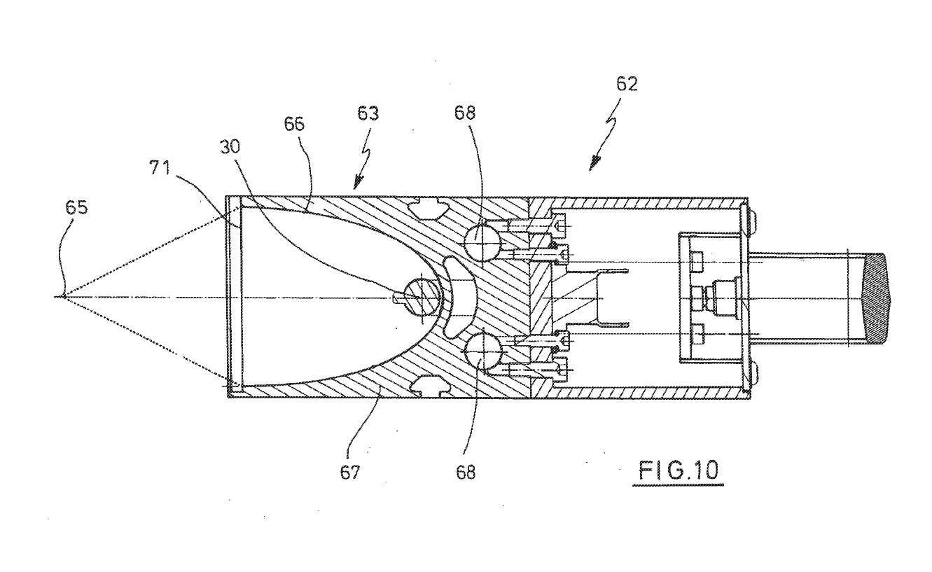

FIG. 10 is a cross sectional view, on a larger scale and with more detail, in the area of the reflector and with corresponding radiator tube,

FIG. 11 is a horizontal sectional view of the arrangement of FIG. 9 on the level of the reflector with radiator tube,

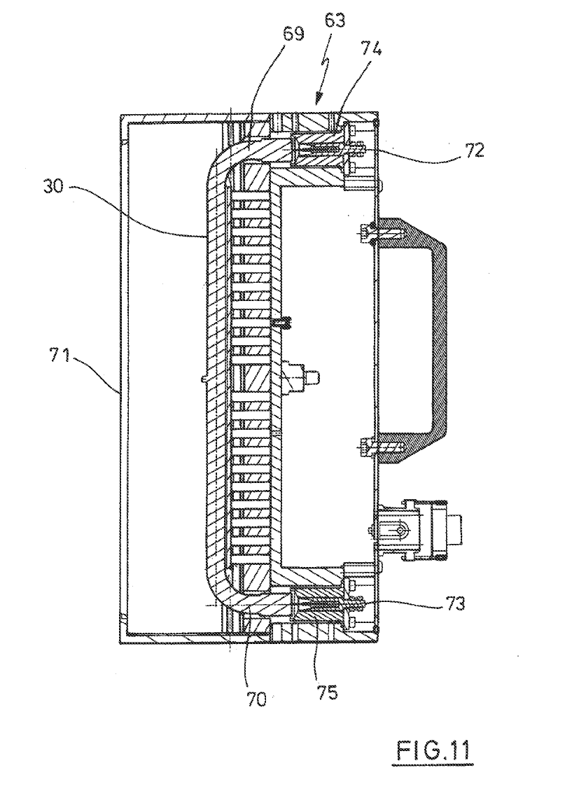

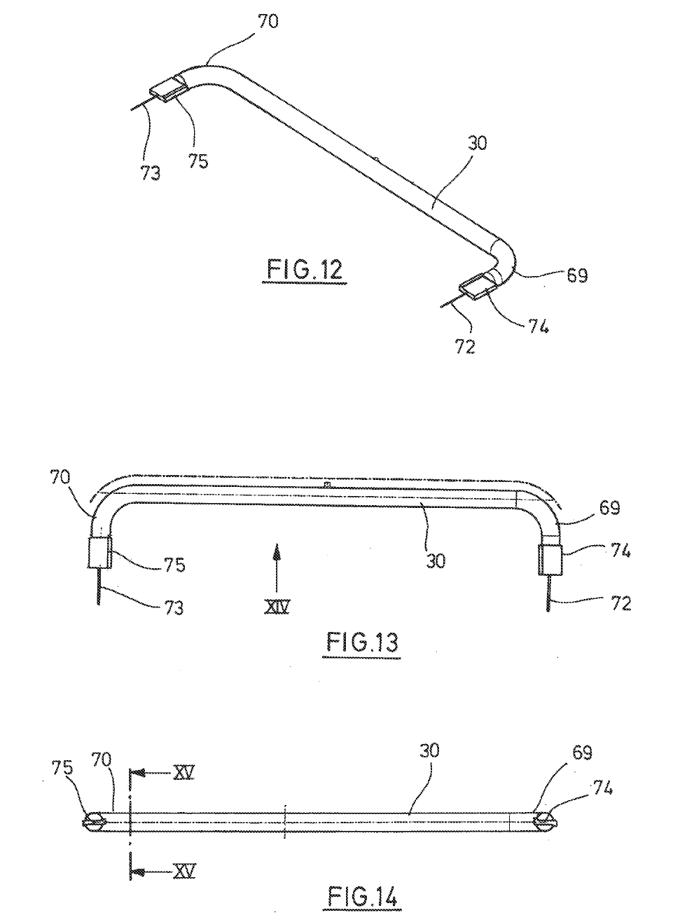

FIG. 12 is a perspective illustration of a radiator tube,

FIG. 13 is a top view of the radiator tube according to FIG. 12,

FIG. 14 is a view of the radiator tube seen in the direction XIV in FIG. 13,

FIG. 15 is a cross sectional view through the radiator tube along sectional line XV-XV in FIG. 14, and

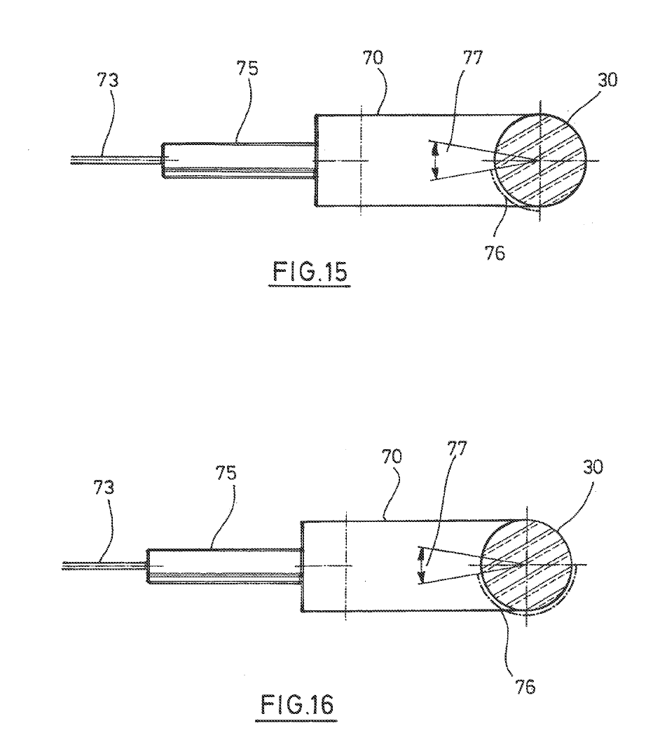

FIG. 16 shows an embodiment modified relative to the embodiment of FIG. 15 with an increased coating surface of the radiator tube.

The principal construction of a device for deforming preforms 1 into containers 2 is illustrated in FIG. 1 and in FIG. 2.

The device for forming the containers 2 consists essentially of a blow molding station 3 which is provided with a blow mold 4 into which a preform 1 can be placed. The preform 1 may be an injection molded part of polyethylene terephthalate. For facilitating placement of preform 1 into the blow mold 4 and for facilitating a removal of the finished container 2, the blow mold 4 consists of mold halves 5, 6 and a bottom part 7 which can be positioned by means of a lifting device 8. The preform 1 may be supported in the area of the blow molding station 3 by a transport mandrel 9 which, together with the preform 1, travels through a plurality of treatment stations within the device. However, it is also possible to place the preform 1 directly into the blow mold 4, for example, by means of tongs or other manipulating means.

For facilitating a supply of compressed air, a connecting piston 10 is arranged underneath the transport mandrel 9 which supplies compressed air to the preform 1 and simultaneously effects a sealing action relative to the transport mandrel 9. However, in a modified construction, it is also basically conceivable to use stationary compressed air supply lines.

A stretching of the preform 1 takes place in this embodiment by means of a stretching rod 11, which is positioned by a cylinder 12. In accordance with another embodiment, a mechanical positioning of the stretching rod 11 is carried out by means of curved segments which are acted upon by gripping rollers. The use of curved segments is particularly advantageous if a plurality of blow molding stations 3 are arranged on a rotating blow wheel.

In the embodiment illustrated in FIG. 1, the stretching system is constructed such that a tandem arrangement of two cylinders 12 is made available. Initially, prior to the beginning of the actual stretching process proper, the stretching rod 11 is moved by a primary cylinder 13 into the area of a bottom 14 of the preform 1. During the actual stretching process proper, the primary cylinder 13 is positioned, with extended stretching rod together with a carriage 15 supporting the primary cylinder 13, by means of a secondary cylinder 16 or by a cam control. In particular, it is intended to use the secondary cylinder 16 through cam control, such that an actual stretching position is predetermined by a guide roller 17, which slides along a curved track while the stretching process is carried out. The guide roller 17 is pressed against the guide track by the secondary cylinder 16. The carriage 15 slides along two guide elements 18.

After closing the mold halves 5, 6 arranged in the area of the supports 19, 20, the supports 19, 20 are locked relative to each other by means of a locking device 20.

For the adaptation to different shapes of the sections of an opening section 21, according to FIG. 2, the use of separate threaded inserts 22 in the area of the blow mold. 4 is contemplated.

FIG. 2 shows, in addition to the blow molded container 2, the preform 1 in broken lines, and schematically a developing container bubble 23.

FIG. 3 shows the basic construction of a blow molding machine provided with a heating section 24 as well as a rotating blow wheel 25. Starting at a preform inlet 26, the preforms 1 are transported into the area of the heating section 24 by means of transfer wheels 27, 28, 29. Heating radiators 30, as well as blowers 31, are arranged along the heating section 24 in order to thermally condition the preforms 1. After a sufficient thermal conditioning, the preforms 1 are transferred to the blow wheel 25 in whose area the blow molding stations 3 are arranged. The finished blow molded containers 2 are fed by means of additional transfer wheels to an outlet section 32.

In order to be able to deform a preform 1 into a container 2, such that the container 2 has material properties which ensure a long usability of foodstuffs filled into the container 2, particularly beverages, special method steps must be adhered to when heating and orienting the preforms 1. Moreover, advantageous effects can be achieved by adhering to special dimensioning regulations.

Various synthetic materials can be used as thermoplastic materials. For example, PET, PEN or PP can be used.

The expansion of the preform 1 during the orienting process is effected by a compressed air supply. The compressed air supply is divided into a pre-blowing phase in which gas, for example compressed air with a low pressure level, is supplied and a subsequent principal blowing phase in which gas is supplied at a higher pressure level. During the pre-blowing phase, typically compressed air, having a pressure in the interval of 10 bar to 25 bar, and during the principal blowing phase compressed air in the interval of 25 bar to 40 bar, is supplied.

From FIG. 3 it can also be seen that, in the illustrated embodiment, the heating section 24 is constructed of a plurality of circumferential transport elements 33 which are arranged in a row in the form of a chain and are guided along guide wheels 34. In particular, it is intended to span an essentially rectangular basic contour by the chain-like arrangement. In the illustrated embodiment, in the area of the extension of the heating section 24 facing the transfer wheel 29 and an input wheel 35, an individual guide wheel 34 having a relatively large dimension is used, and in the area of adjacent deflections, two guide wheels 36 having a comparatively smaller dimension are used. However, basically any other chosen guide means are conceivable.

For facilitating an arrangement of the guide wheel 29 and the input wheel 35 relative to each other, the illustrated arrangement has been found to be particularly useful because three guide wheels 34, 36 are positioned in the area of the corresponding extension of the heating section 24, namely the respectively smaller guide wheels 36 in the area of the transition to the linear patterns of the heating section 24, and the larger guide wheel 34 in the immediate transfer area to the transfer wheel 29 and the input wheel 35. As an alternative to using chain-like transport elements 33, it is also possible, for example, to use a rotating heating wheel.

After blow molding of the containers 2 is finished, the containers 2 are removed by a removal wheel 37 from the area of the blow molding stations 3, and are transported to the outlet section 32 by the transfer wheel 28 and an outlet wheel 38 to the outlet section 32.

In the modified heating section illustrated in FIG. 4, a greater number of preforms 1 can be thermally conditioned per unit of time because of the greater number of heating radiators 30. For this purpose, the blowers 31 conduct cooling air into the area of cooling air ducts 39 which are each arranged opposite the corresponding heating radiators 30, and discharge cooling air through outlet openings. By arranging the outlet directions, a flow direction for the cooling air essentially transversely of a transport direction of the preforms 1 is realized. The cooling air ducts 39 can make available, in the area of surfaces located opposite the heating radiators 30, reflectors for the heating radiation. Also, it is possible to realize cooling of the heating radiators by means of the discharged cooling air.

FIG. 5 shows a perspective illustration of a heating module 41 which is intended for arrangement in the area of the heating section 24. The heating module 41 is provided with a heating duct 42, through which the preforms 1 are moved. The heating duct 42 is constructed essentially according to a U-profile and includes a closed bottom 43. Laterally, the heating duct 42 is defined by a side reflector 44 as well as a heating box 45. The heating radiators 30, not visible in FIG. 5, are positioned in the area of the heating box 45.

Opposite the bottom 43, the heating duct 42 is defined by reflector 46. In the illustrated embodiment, the reflector 46 is constructed as a wall of an air conducting element 47 which wall faces the heating duct 42, wherein the air conducting element 47 defines a flow duct 48.

FIG. 6 shows a cross sectional view of the heating module 41, in accordance with FIG. 5, with additional preforms and holding element 49 being shown. The holding element 49 has a support 50 along which extends a rod-like transport element 51. In the area of its extension facing the preform 1, the transport element 51 is connected to a fixing head 52 which can be inserted into the opening 21 of the preform 1, and can be tensioned in this area. As a result, the preform 1 can be transported by the transport element 51 in a defined position through the heating duct 42.

In the illustrated embodiment, the reflector 46 has a collar 53 arranged adjacent the opening section 21, for screening the opening section 21, and a support ring 54 of the preform 1 against an influence of heating radiation, in order to prevent or reduce heating in this area.

In FIG. 6, it can also be seen that the side reflector 44 is supported by a cooling body 55 which includes a flow duct 56. Cooling air flows into the air duct through an inlet opening 57 and exits through an outlet opening 58. In particular, it is intended to arrange the inlet opening 57 in the vertical direction in a lower area of the flow duct 56, and to arrange the outlet opening 58 in an upper lateral part of the flow duct 56 in the vertical direction. A vertical positioning of the outlet opening 58 preferably takes place, such that the outlet opening 58 is arranged on the same vertical level as the opening section 21 of the preform 1. The cooling air discharged from the cooling body 55 flows around the opening section 21 and thereby cools the latter.

In particular, it is also being considered to position an inlet opening 59 of the air conducting element 57 opposite the outlet opening 58. The air emerging from the cooling body 55 is thus also conducted through the air conducting element 47, and causes cooling of the reflector 46.

In the area of the heating box 45, a plurality of heating radiators 30 are arranged above each other in the vertical direction. For realizing a frequency-selective heating, a filter disk 60 is arranged between the heating radiators 30 and the heating duct 42 of a filter disk 60. In accordance with an advantageous embodiment, the heating radiators 30, as well as the filter disk 60, are thermally conditioned by the cooling air.

In the area of a direction facing away from the filter disk 60, behind the heating radiators 30, a radiation reflector 61 is arranged which preferably includes a profiled reflector surface. The reflector surface is preferably structured in such a way that a return radiation into the heating radiator 30 is avoided, and the formation of a suitable heat distribution in the area of the heating duct 42 is reinforced.

In accordance with the embodiment in FIG. 6, the reflector 46 is formed in such a way that a trapezoidal basic contour is made available, wherein the trapezoid is open in the direction toward the heating box 45. Starting from this trapezoidal contour, the collar 53 extends essentially horizontally in the direction toward the preform 1.

The reflector 46 is preferably made of metal. In particular, the use of polished or mirrored aluminum is contemplated.

FIG. 7 shows a heating device 62 which is basically of similar construction as the heating box 45. The heating device 32 includes a focusing reflector 63. The focusing reflector 63 extends essentially in the direction of a transport path 64 of the preforms 1.

From the top view of FIG. 8 it can be seen that, oppositely located of the focusing reflector 63, is also arranged a side reflector 44 similar to the construction of the heating box 45.

From the cross sectional view of FIG. 9, it can be seen that the focusing reflector 63 has in the cross section a configuration similar to an ellipse. In the illustrated embodiment, the focusing reflector 63 extends in its shape configured similar to half an ellipse, wherein this elliptical contour is open in the direction toward the side reflector 44, so that the heat radiation emitted by the tube-like heating radiator 30 can discharge in the direction toward the side reflector 44. While the heating process is carried out, the preform 1 to be heated and to be profiled with respect to its temperature is located between the focusing reflector 63 and the side reflector 44.

FIG. 10 is a cross sectional view of the focusing reflector 63 on a larger scale and with more detail. The focusing reflector 63 has a focal point 65 and, in the material of a reflector support 67 defining a reflector surface 66 cooling ducts 68 are arranged for cooling the reflector carrier 67 with a cooling fluid, for example, water.

FIG. 11 shows in a more detailed horizontal sectional view, in particular the arrangement the heating radiator 30 in the area of the focusing reflector 63. It can be seen that the heating radiator 30 extends in the manner of tubes and is in the area of end sections 69, 70 bent by about 90°. As seen from an outlet opening 71 of the focusing reflector 63, the end sections 69, 70 are bent toward the rear, such that the contacts 72, 73 extend out of the area of high heating intensity. Typically, the contacts 72, 73 are surrounded by thermal insulators 74, 75.

From a combined view of FIG. 10 and FIG. 11, it can be seen that the heating radiator 30, as seen from the outlet opening 71, is arranged relatively deep within the focusing reflector 63 and, consequently, extends at a relatively short distance to the inner turning point of the reflector surface 66.

FIG. 12 shows a heating radiator 30 removed from the focusing reflector 63. Especially the end sections 69, 70 connected to the contacts 72, 73 and the insulators 74, 75 can be seen.

FIG. 13 shows a top view of the heating radiator 30 according to FIG. 12. An area for screening 76, which will be explained in more detail in connection with FIG. 15 and FIG. 16, is shown in dash-dot lines.

FIG. 14 once again shows in a side view, the construction of the heating radiator 30.

FIG. 16 illustrates in a cross sectional view the arrangement of screening 76 in the area of the heating radiator 30. In particular, it is intended to apply the screening 76 as a coating directly on the material of the heating radiator 30. Typically, a wall of the heating radiator 30 consists of quartz glass. Ceramic substances are preferred as the material for the use of screening 76.

In accordance with the embodiment in FIG. 15, the screening 76 extends over a circumferential angle of the heating radiator 30 of about 80°. In the illustrated embodiment, the area of the screening 76 begins approximately at a vertical center line of the heating radiator 30 and extends in the area of the surface of the heating radiator 30 facing the reflector surface 66. Consequently, the screening 76 prevents an impingement of heating radiation against areas of the reflector surface 66 which have less curvature. A reference angle 77, shown in FIG. 15, is about 20°.

In accordance with another embodiment in FIG. 16, the screening 76 extends over a circumferential angle in the area of the heating radiator 30 of about 170°. The arrangement corresponds otherwise at least essentially to the embodiment of FIG. 15.

An aluminum oxide can be used, for example, as the material for the screening 76. For example, Al₂O₃ is being considered. A typical thickness of the screening 56 is 50 micrometers, wherein a preferred thickness range is 40 micrometers to 60 micrometers. However, layer thicknesses in a range of 10 micrometers to 100 micrometers have also been found useful.

The heating device 62 according to the invention can be provided, similar to the heating module 41 in FIG. 6, with a filter disk 60, for example, a quartz glass pane. In the embodiment of FIG. 10, such a filter disk 60 would be preferably arranged in the area of the outlet opening 71. Advantageous is the use of such a filter disk 60, in particular for heating preforms 1, which have a wall thickness of more than 4 mm. In preforms 1 having smaller wall thicknesses, the use of such a filter disk 60 is easily also omitted, wherein, however, the use of a filter disk 60 is never a disadvantage.

The heating device 62 according to the invention is preferably arranged in the area of a blow molding machine behind the heating elements as seen in a transport direction of the preforms 1 for producing a basic temperature of the preforms 1. Accordingly, the present invention also relates to a blow molding machine which is constructed with the use of the appropriate basic temperature, as well as of the heating device 62 according to the invention. The measures described above for reinforcing the temperature profiling, namely, the use of the focusing reflector 63 on the one hand, and on the other hand, the use of the screening 76 can take place individually as well as in combination. In a combined use, the achievable advantages add up.

1-22. (canceled)

23. A method of blow molding containers, comprising the steps of: deforming a preform of a thermoplastic material, after thermal conditioning, into a container along a transport path in an area of a heating section within a blow mold by influence of blowing pressure; providing the preform, at least along a portion of its transport path in the area of the heating section, which has at least one tube-like heating radiator, with a temperature profile that extends in a longitudinal direction of the preform; and positioning the heating radiator with a heating device so that radiation emission of the heating radiator in different spatial directions with different intensities.

24. The method according to claim 23, including using a focusing reflector for influencing spreading of the heating radiation.

25. The method according to claim 24, including providing the focusing reflector, at least over areas thereof, with an ellipse-like shape.

26. The method according to claim 24, wherein the heating radiator has end sections that are bent in a direction toward a reflector surface, the method including positioning the heating radiator in an area of the focusing reflector.

27. The method according to claim 26, wherein the heating radiator is a heating radiator for generating a NIR-radiation.

28. The method according to claim 26, including positioning the heating radiator in a receiving space defined by the focusing reflector, and at a short distance from the reflector surface.

29. The method according to claim 23, including using at least one screening for shading.

30. The method according to claim 29, including using the screening for covering at least one circumferential area of the heating radiator.

31. The method according to claim 29, including positioning the screening as a coating on the heating radiator.

32. The method according to claim 29, including using a ceramic material as the screening.

33. The method according to claim 23, including positioning the heating device at an end of a heating section.

34. A device for blow molding containers of a thermoplastic material, comprising: at least one heating section arranged at least along a portion of a transport path of a preform; a blow molding station provided with a blow mold; a device for producing a temperature profile is arranged in an area of the preform along at least a portion of the transport path of the preform, wherein the temperature profile extends in a longitudinal direction of the preform, and wherein at least one tube-like heating radiator is provided in the area of a heating device for generating a heating radiation, the heating device positioning the heating radiator so that radiation emission of the heating radiator is radiated with different intensities in different spatial directions.

35. The device according to claim 34, wherein the heating device has at least one focusing reflector.

36. The device according to claim 35, wherein the focusing reflector has an at least partially ellipse-like reflector surface.

37. The device according to claim 36, wherein the heating radiator has end sections bent toward the reflector surface.

38. The device according to claim 34, wherein the heating radiator is configured for generating NIR-radiation.

39. The device according to claim 36, wherein the heating radiator is arranged at a short distance from the reflector surface.

40. The device according to claim 34, further comprising a screening at least over portions of the heating radiator.

41. The device according to claim 40, wherein the screening extends along a partial area of a circumference of the heating radiator.

42. The device according to claim 40, wherein the screening is at least over areas thereof constructed as a coating.

43. The device according to claim 40, wherein the screening is at least over portions thereof made of ceramic material.

44. The device according to claim 34, wherein the heating device is positioned at an end of a heating section of a blow molding machine, for carrying out a temperature profiling of the preform, after a basic thermal conditioning of the preform.
